(19) United States
(12) Patent Application Publication
(10) Pub. No.: US 2023/0214630 A1
(43) Pub. Date: Jul. 6, 2023

(54) CONVOLUTIONAL NEURAL NETWORK SYSTEM, METHOD FOR DYNAMICALLY DEFINING WEIGHTS, AND COMPUTER-IMPLEMENTED METHOD THEREOF

(71) Applicant: CRON AI LTD. (UK), London (GB)

(72) Inventor: Robert de TEMPLE, Essen (DE)

(73) Assignee: CRON AI LTD. (UK), London (GB)

(21) Appl. No.: 17/646,569

(22) Filed: Dec. 30, 2021

(51) Int. Cl. G06N 3/04; G06N 3/08

(52) U.S. Cl. CPC G06N 3/0454; G06N 3/08

(57) ABSTRACT

A convolutional neural network system comprising at least one sensor, a convolutional neural network, and a weight generation network is provided. The convolutional neural network includes a plurality of convolution layers including corresponding one or more convolution kernels to generate one or more feature maps. The weight generation network includes a plurality of weight generators. One or more of the weight generators are configured to dynamically generate one or more weights for the one or more convolution kernels of one or more of the convolution layers at a run-time based on a vector. The vector is based on one or more weight indicators indicative of the one or more weights generated by a previous weight generator.

### TECHNICAL FIELD

The present disclosure relates to a convolutional neural network system, a method for dynamically defining weights, and a computer-implemented method thereof.

### BACKGROUND

Convolutional neural networks (CNNs) are generally used to provide image recognition. Since the CNNs used nowadays for image recognition use deeper networks with higher number of convolutions, higher computational, memory, and power resources may be required to run the CNNs on an embedded hardware.

### SUMMARY

In a first aspect, the present disclosure provides a convolutional neural network system. The convolutional neural network system comprises at least one sensor configured to generate sensor data. The convolutional neural network system further comprises a convolutional neural network. The convolutional neural network comprises a plurality of sequentially arranged convolution layers comprising corresponding one or more convolution kernels. Each of the plurality of sequentially arranged convolution layers is configured to receive a corresponding previous data. The corresponding previous data is convolved with the corresponding one or more convolution kernels to generate one or more feature maps. The sensor data is the corresponding previous data for a first convolution layer from the plurality of sequentially arranged convolution layers. The one or more feature maps are the corresponding previous data for a subsequent convolution layer from the plurality of sequentially arranged convolution layers. The one or more feature maps of a final convolution layer from the plurality of sequentially arranged convolution layers comprise output data. The convolutional neural network system further comprises a weight generation network communicably coupled to the convolutional neural network. The weight generation network comprises a plurality of sequentially arranged weight generators coupled to the plurality of sequentially arranged convolution layers. One or more of the plurality of sequentially arranged weight generators are configured to dynamically generate one or more weights for the one or more convolution kernels of one or more of the plurality of sequentially arranged convolution layers at a run-time based on a vector. The vector is based on one or more weight indicators indicative of the one or more weights generated by a previous weight generator.

In a second aspect, the present disclosure provides a computer-implemented method for dynamically generating weights for a convolutional neural network. The method comprises generating sensor data. The method further comprises providing a convolutional neural network comprising a plurality of sequentially arranged convolution layers. The method further comprises initializing the convolution neural network. The method further comprises defining corresponding one or more convolution kernels in each of the plurality of sequentially arranged convolution layers. The method further comprises receiving corresponding previous data by each of the plurality of sequentially arranged convolution layers. The method further comprises convoluting the corresponding previous data with the corresponding one or more convolution kernels to generate one or more feature maps. The sensor data is the corresponding previous data for a first convolution layer from the plurality of sequentially arranged convolution layers. The one or more feature maps are the corresponding previous data for a subsequent convolution layer from the plurality of sequentially arranged convolution layers. The one or more feature maps of a final convolution layer from the plurality of sequentially arranged convolution layers comprise output data. The method further comprises providing a weight generation network communicably coupled to the convolutional neural network and comprising a plurality of sequentially arranged weight generators coupled to the plurality of sequentially arranged convolution layers. The method further comprises dynamically generating one or more weights for the one or more convolution kernels of one or more of the plurality of sequentially arranged convolution layers at a run-time based on a vector. The vector is based on one or more weight indicators indicative of the one or more weights generated by a previous weight generator.

In a third aspect, the present disclosure provides a computer program product comprising a computer readable medium having computer readable code embodied therein. The computer readable code is configured such that, on execution by a suitable computer unit, causes the computer unit to generate sensor data. Further, the computer readable code is configured such that, on execution by the computer unit, causes the computer unit to provide a convolutional neural network comprising a plurality of sequentially arranged convolution layers. Further, the computer readable code is configured such that, on execution by the computer unit, causes the computer unit to initialize the convolution neural network. Further, the computer readable code is configured such that, on execution by the computer unit, causes the computer unit to define corresponding one or more convolution kernels in each of the plurality of sequentially arranged convolution layers. Further, the computer readable code is configured such that, on execution by the computer unit, causes the computer unit to receive corresponding previous data by each of the plurality of sequentially arranged convolution layers. Further, the computer readable code is configured such that, on execution by the computer unit, causes the computer unit to convolve the corresponding previous data with the corresponding one or more convolution kernels to generate one or more feature maps. The sensor data is the corresponding previous data for a first convolution layer from the plurality of sequentially arranged convolution layers. The one or more feature maps are the corresponding previous data for a subsequent convolution layer from the plurality of sequentially arranged convolution layers. The one or more feature maps of a final convolution layer from the plurality of sequentially arranged convolution layers comprise output data. Further, the computer readable code is configured such that, on execution by a suitable computer unit, causes the computer unit to provide a weight generation network communicably coupled to the convolutional neural network and comprising a plurality of sequentially arranged weight generators coupled to the plurality of sequentially arranged convolution layers. Further, the computer readable code is configured such that, on execution by the computer unit, causes the computer unit to dynamically generate one or more weights for the one or more convolution kernels of one or more of the plurality of sequentially arranged convolution layers at a run-time based on a vector. The vector is based on one or more weight indicators indicative of the one or more weights generated by a previous weight generator.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein is more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labelled with the same number.

FIG. 1A illustrates a schematic block diagram of a convolutional neural network system including a convolutional neural network, and a weight generation network, according to an embodiment of the present disclosure;

FIG. 1B illustrates a schematic diagram of an exemplary weight generator of the weight generation network;

FIG. 1C illustrates a schematic diagram of an exemplary features statistic module of the convolutional neural network system;

FIG. 1D illustrates a schematic diagram of an exemplary feature map of a convolution layer of the convolutional neural network;

FIG. 2 illustrates a schematic block diagram of a convolutional neural network system, according to another embodiment of the present disclosure; and

FIG. 3 illustrates a flowchart depicting a computer-implemented method for dynamically generating weights for a convolutional neural network, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and is made without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/- 20 % for quantifiable properties).

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, “at least one of A and B” should be understood to mean “only A, only B, or both A and B”.

As used herein, the terms “communicably coupled to” and “communicably connected to” refers to direct coupling between components and/or indirect coupling between components via one or more intervening components. Such components and intervening components may comprise, but are not limited to, junctions, communication paths, components, circuit elements, circuits, functional blocks, and/or devices. As an example of indirect coupling, a signal conveyed from a first component to a second component may be modified by one or more intervening components by modifying the form, nature, or format of information in a signal, while one or more elements of the information in the signal are nevertheless conveyed in a manner than can be recognized by the second component.

Convolutional neural networks (CNNs) are generally used to provide image recognition. Since the CNNs used nowadays for image recognition use deeper networks with higher number of convolutions, higher computational, memory, and power resources may be required to run the CNNs on an embedded hardware.

Therefore, it may be advantageous to perform image recognition with high accuracy, and with less computational, memory, and power resource requirements. Such improvements may become critical as the desire to perform image recognition becomes more widespread.

Typically, in conventional convolutional neural networks, there may be a momentary redundancy when one or more feature maps of any of convolution layers of the conventional convolutional neural network are not required for processing a current input at a particular instance. Specifically, corresponding convolution kernels of some of the convolution layers may not be relevant at the particular instance. For example, when the current input at the particular instance may be related to a dog, the corresponding convolution kernels of the some of the convolution layers related to an umbrella may not be relevant at the particular instance. However, they may be relevant for different inputs (e.g., the inputs related to the umbrella) at other instances.

Since there may be a high variability of possible inputs to the convolutional neural networks, there may be a need to dynamically determine relevant convolution kernels and relevant feature maps for the current input.

In an aspect, the present disclosure provides a convolutional neural network system. The convolutional neural network system comprises at least one sensor configured to generate sensor data. The convolutional neural network system further comprises a convolutional neural network. The convolutional neural network comprises a plurality of sequentially arranged convolution layers comprising corresponding one or more convolution kernels. Each of the plurality of sequentially arranged convolution layers is configured to receive a corresponding previous data. The corresponding previous data is convolved with the corresponding one or more convolution kernels to generate one or more feature maps. The sensor data is the corresponding previous data for a first convolution layer from the plurality of sequentially arranged convolution layers. The one or more feature maps are the corresponding previous data for a subsequent convolution layer from the plurality of sequentially arranged convolution layers. The one or more feature maps of a final convolution layer from the plurality of sequentially arranged convolution layers comprise output data. The convolutional neural network system further comprises a weight generation network communicably coupled to the convolutional neural network. The weight generation network comprises a plurality of sequentially arranged weight generators coupled to the plurality of sequentially arranged convolution layers. One or more of the plurality of sequentially arranged weight generators are configured to dynamically generate one or more weights for the one or more convolution kernels of one or more of the plurality of sequentially arranged convolution layers at a run-time based on a vector. The vector is based on one or more weight indicators indicative of the one or more weights generated by a previous weight generator.

The weight generation network of the CNN system of the present disclosure may dynamically define the one or more weights for the corresponding convolution layer from the convolution layers via the weight generators. In other words, the convolutional kernels are defined at a run-time and are not hard-coded. This may reduce the momentary redundancy of the one or more feature maps from the one or more feature maps and the convolution kernels of any of the convolution layers that are not required for processing the current input. Therefore, the convolutional neural network may use fewer computations, require less memory, and/or consume less power than the conventional neural networks.

Further, since the one or more weights for the corresponding convolution layer may be dynamically defined by the weight generation network of the CNN system, a size of the convolutional neural network may be reduced without negatively affecting the accuracy of the CNN system. Specifically, a number of the convolution kernels may be reduced, which in turn may reduce a number of feature maps. Therefore, the weight generation network of the CNN system may provide a compression that may reduce the number of active feature maps at any instance in the convolutional neural network. This may reduce computational, memory, and power resources requirement of the convolutional neural network. Thus, the CNN system may have improved computational efficiency may result in reduced run-time of the convolutional neural network. This may further enable the implementation of the convolutional neural network in a computing device having strict power, storage, and computational resources constraints.

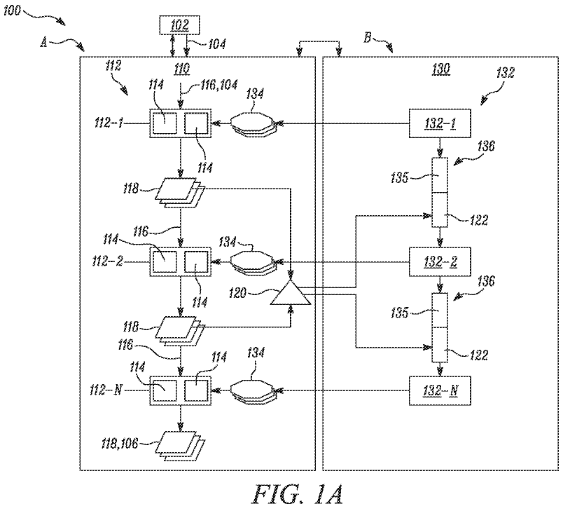

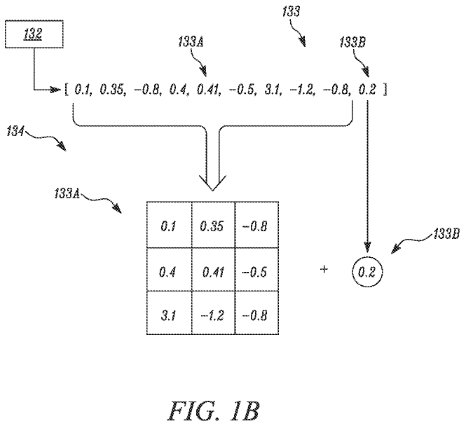

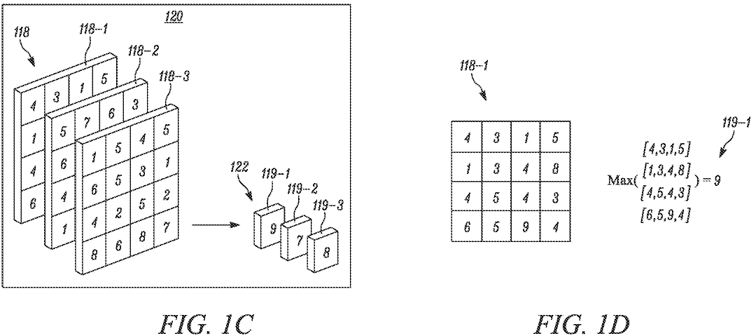

Referring now to figures, FIG. 1A illustrates a schematic block diagram of a convolutional neural network (CNN) system 100, according to an embodiment of the present disclosure.

The CNN system 100 includes at least one sensor 102 configured to generate sensor data 104. In some embodiments, the at least one sensor 102 includes a light detection and ranging (LIDAR) sensor. In some embodiments, the sensor data 104 includes point cloud data. In some other embodiments, the at least one sensor 102 may include one or more cameras, or the like. In some embodiments, the sensor data 104 includes image data. In some other embodiments, the at least one sensor 102 may include a radio detection and ranging (RADAR) sensor, a sound navigation and ranging (SONAR) sensor, or a combination thereof.

The CNN system 100 further includes a convolutional neural network 110. In some embodiments, the convolutional neural network 110 may be implemented in a computing device A. The convolutional neural network 110 is communicably coupled to the at least one sensor 102. Specifically, the computing device A may be communicably coupled to the at least one sensor 102. In some embodiments, the computing device A may include a system-on-chip (SOC), a computer processing unit (CPU), a graphical processing unit (GPU), or any other processing system. In some embodiments, the computing device A may have low power, storage, and/or computational resources.

Examples of the computing device A may include a personal computer (PC), a laptop, a tablet, a touch pad, a portable computer, a handheld computer, a palmtop computer, a personal digital assistant (PDA), a smart device (e.g., smart phone, smart tablet, or smart mobile television), a mobile internet device (MID), a data communication device, and so forth. In some examples, the computing device A also may include devices that are configured to be worn by a person, such as a wrist-computers, finger computers, ring computers, eyeglass computers, belt-clip computers, arm-band computers, shoe computers, clothing computers, and other wearable computers. In some embodiments, the computing device A may be capable of executing other applications, as well as voice communications and/or data communications.

The convolutional neural network 110 includes a plurality of sequentially arranged convolution layers 112. The plurality of sequentially arranged convolution layers 112 may be interchangeably and collectively referred to as “the convolution layers 112”. In some embodiments, the convolution layers 112 includes a first convolution layer 112-1 and a final convolution layer 112-N. In the illustrated embodiment of FIG. 1A, the convolution layers 112 further includes one convolution layer 112-2 arranged between the first convolution layer 112-1 and the final convolution layer 112-N. In some other embodiments, the convolution layers 112 may include any number of convolution layers sequentially arranged between the first convolution layer 112-1 and the final convolution layer 112-N.

The plurality of sequentially arranged convolution layers 112 include corresponding one or more convolution kernels 114 (schematically shown in FIG. 1A). In some embodiments, the convolution layers 112 may include a same number of the convolution kernels 114. For example, each of the convolution layers 112 may include sixteen convolution kernels 114. However, in some other embodiments, the convolution layers 112 may include a different number of the convolution kernels 114. For example, the first convolution layer 112-1 may include sixty-four convolution kernels 114, the convolution layer 112-2 may include sixteen convolution kernels 114, and the final convolution layer 112-N may include four convolution kernels 114.

Each of the convolution layers 112 is configured to receive corresponding previous data 116. The corresponding previous data 116 is convolved with the corresponding one or more convolution kernels 114 to generate one or more feature maps 118. The sensor data 104 is the corresponding previous data 116 for the first convolution layer 112-1 from the convolution layers 112. Further, the one or more feature maps 118 are the corresponding previous data 116 for a subsequent convolution layer from the convolution layers 112. Furthermore, the one or more feature maps 118 of the final convolution layer 112-N from the plurality convolution layers 112 include output data 106.

For example, in the illustrated embodiment of FIG. 1A, the sensor data 104 is the previous data 116 for the first convolution layer 112-1 from the convolution layers 112. Further, the one or more feature maps 118 generated by the first convolution layer 112-1 is the previous data 116 for the convolution layer 112-2. Similarly, the one or more feature maps 118 generated by the convolution layer 112-2 is the previous data 116 for the final convolution layer 112-N. The one or more feature maps 118 of the final convolution layer 112-N include the output data 106.

The CNN system 100 further includes a weight generation network 130. In some embodiments, the weight generation network 130 may be implemented in a computing device B. The weight generation network 130 is communicably coupled to the convolutional neural network 110. Specifically, the computing device B may be communicably coupled to the computing device A. The weight generation network 130 may be selectively coupled to the convolutional neural network 110. In some embodiments, the weight generation network 130 includes a multi-layer perceptron (MLP) structure. In some embodiments, the computing device B may be substantially similar to the computing device A. In other words, the computing device B may have low power, storage, and/or computational resources.

The weight generation network 130 includes a plurality of sequentially arranged weight generators 132 coupled to the plurality of sequentially arranged convolution layers 112. The plurality of sequentially arranged weight generators 132 may be interchangeably and collectively referred to as “the weight generators 132”.

In some embodiments, the weight generation network 130 includes a first weight generator 132-1 and a final weight generator 132-N. In the illustrated embodiment of FIG. 1A, the weight generators 132 further includes one weight generator 132-2 arranged between the first weight generator 132-1 and the final weight generator 132-N. In some other embodiments, the weight generators 132 may include any number of weight generators sequentially arranged between the first weight generators 132-1 and the final weight generator 132-N. In some embodiments, a total number of the weight generators 132 may be less than a total number of the convolution layers 112. In such embodiments, one or more of the weight generators 132 may correspond to two or more of the convolution layers 112.

In some embodiments, the weight generators 132 correspond to the convolution layers 112. For example, the first weight generator 132-1 may correspond to the first convolution layer 112-1, the weight generator 132-2 may correspond to the convolution layer 112-2, the final weight generator 132-N may correspond to the final convolution layer 112-N. In such embodiments, the total number of the weight generators 132 may be equal to the total number of the convolution layers 112.

In some embodiments, one or more of the weight generators 132 are configured to dynamically generate one or more weights 134 for the one or more convolution kernels 114 of one or more of the convolution layers 112 at a run-time based on a vector 136. In some embodiments, the one or more weights 134 may be re-used for the one or more convolution kernels 114 of one or more of the convolution layers 112 when the weight generation network 130 is not coupled to the computing device A. In some embodiments, each weight generator 132 is configured to dynamically generate the one or more weights 134 for the one or more convolution kernels 114 of one or more of the convolution layers 112 at the run-time based on the vector 136. In some embodiments, a subsequent weight generator from the weight generators 132 receives the vector 136 as an input to dynamically generate the one or more weights 134 for the one or more convolution kernels 114 of the corresponding convolution layer 112 at the run-time. The weight generators 132 further generate one or more weight indicators 135 indicative of the one or more weights 134. The vector 136 is based on the one or more weight indicators 135 indicative of the one or more weights 134 generated by a previous weight generator 132. The one or more weight indicators 135 may provide context to the weight generator 132. Specifically, the one or more weight indicators 135 may provide context to the subsequent weight generator 132.

For example, the vector 136 used to generate the one or more weights 134 for the one or more convolution kernels 114 of the convolution layer 112-2 may be based on the one or more weight indicators 135 indicative of the one or more weights 134 generated by the first weight generator 132-1. Further, the vector 136 used to generate the one or more weights 134 for the one or more convolution kernels 114 of the final convolution layer 112-N may be based on the one or more weight indicators 135 indicative of the one or more weights 134 generated by the weight generator 132-2.

In some embodiments, the weight generators 132 are configured to dynamically generate the one or more weights 134 for the one or more convolution kernels 114 of the convolution layers 112 at the run-time based on the one or more feature maps 118 generated by the one or more preceding convolution layers 112.

In some cases, one or more of the weight generators 132 may be configured to dynamically generate the one or more weights 134 for the one or more convolution kernels 114 of the corresponding convolution layer 112 at the run-time further based on the feature maps 118 generated by a previous convolution layer 112. For example, the weight generator 132-2 may be configured to dynamically generate the one or more weights 134 for the one or more convolution kernels 114 of the convolution layer 112-2 at the run-time further based on the feature maps 118 generated by the first convolution layer 112-1.

In some embodiments, the CNN system 100 further includes a features statistic module 120 configured to receive the one or more feature maps 118 and compute statistical parameters 122 for one or more of the convolution layers 112 based on the corresponding one or more feature maps 118. The features statistic module 120 may be configured to receive the one or more feature maps 118 and compute the statistical parameters 122 for each of the convolution layers 112 based on the corresponding one or more feature maps 118.

For example, the features statistic module 120 may receive the one or more feature maps 118 from the first convolution layer 112-1 and compute the statistical parameters 122 for the first convolution layer 112-1. Similarly, the features statistic module 120 may receive the one or more feature maps 118 from the convolution layer 112-2 and compute the statistical parameters 122 for the convolution layer 112-2. Similarly, the features statistic module 120 may receive the one or more feature maps 118 from the final convolution layer 112-N and compute the statistical parameters 122 for the final convolution layer 112-N. In some embodiments, the statistical parameters 122 include one or more of an average value, a variance value, a maximum value, and a minimum value. In some embodiments, the vector 136 is further based on the statistical parameters 122 of the preceding convolution layers 112.

In some cases, one or more of the weight generators 132 may be configured to dynamically generate the one or more weights 134 for the one or more convolution kernels 114 of the corresponding convolution layer 112 at the run-time further based on a corresponding convolution layer information. For example, the weight generator 132-2 may be configured to dynamically generate the one or more weights 134 for the one or more convolution kernels 114 of the first convolution layer 112-1 and the convolution layer 112-2 at the run-time. When the weight generator 132-2 is generating the one or more weights 134 for the first convolution layer 112-1, the corresponding convolution layer information may provide information to the weight generator 132-2 that the weight generator 132-2 is generating the one or more weights 134 for the first convolution layer 112-1. Similarly, when the weight generator 132-2 is generating the one or more weights 134 for the convolution layer 112-2, the corresponding convolution layer information may provide information to the weight generator 132-2 that the weight generator 132-2 is generating the one or more weights 134 for the convolution layer 112-2.

FIG. 1B illustrates a schematic diagram of an exemplary weight generator 132 of the weight generation network 130. The weight generator 132 may be of any one of the weight generators 132 (shown in FIG. 1A).

Each of the weight generator 132 may generate a list of weights 133. In the illustrated embodiment of FIG. 1B, the list of weights 133 includes one set of weights for one convolution kernel 144 of the corresponding convolution layer 112. In some other cases, the list of weights 133 may include a plurality of sets of weights, i.e., one set of weights for each of the convolution kernels 144 of the corresponding convolution layer 112. In some cases, the list of weights 133 may include a bias value. In some embodiments, each set of weights from the list of weights 133 may be split into a first group 133A and a second group 133B including the bias value. The first group 133A of the list of weights 133 may be reshaped into a shape of the corresponding convolution kernel 144. The reshaped first group 133A and the second group 133B including the bias value may be provided as one of the one or more weights 134 to the corresponding convolution layer 112.

FIG. 1C illustrates a schematic diagram of an exemplary features statistic module 120 of the CNN system 100 and exemplary feature maps 118. The feature maps 118 may be of any one of the convolution layers 112 (shown in FIG. 1A).

In some embodiments, the features statistic module 120 receives the one or more feature maps 118 and computes the statistical parameters 122 for the convolution layers 112 (shown in FIG. 1A) based on the corresponding one or more feature maps 118. In the illustrated embodiment of FIG. 1C, the feature maps 118 includes three feature maps 118-1, 118-2, and 118-3. The statistical parameters 122 may include values 119-1, 119-2, and 119-3 corresponding to the feature maps 118-1, 118-2, and 118-3. Each of the values 119-1, 119-2, and 119-3 may be an average value, a variance value, a maximum value, or a minimum value.

FIG. 1D illustrates a schematic diagram of the exemplary feature map 118-1 and the corresponding value 119-1 of the statistical parameters 122 (shown in FIG. 1C) computed by the features statistic module 120 (shown in FIG. 1C). In the illustrated example, the value 119-1 is the maximum value.

Typically, in conventional convolutional neural networks, there may be a momentary redundancy when one or more feature maps (e.g., the feature maps 118) of any of the convolution layers (e.g., the convolution layers 112) are not required for processing a current input (e.g., the sensor data 104) at a particular instance. Specifically, corresponding convolution kernels (e.g., convolution kernels 114) of the convolution layers may not be relevant at the particular instance. For example, when the current input at the particular instance may be related to a dog, the corresponding convolution kernels of the convolution layers related to an umbrella may not be relevant at the particular instance. However, they may be relevant for different inputs (e.g., the inputs related to the umbrella) at other instances.

Since there may be a high variability of possible inputs to the convolutional neural networks, there may a need to dynamically determine relevant convolution kernels and relevant feature maps for the current input.

Referring to FIGS. 1A-1D, as discussed above, the weight generation network 130 of the CNN system 100 may dynamically define the one or more weights 134 for the corresponding convolution layer from the convolution layers 112 via the weight generators 132. In other words, the convolutional kernels 114 are defined at a run-time and are not hard-coded. This may reduce the momentary redundancy of the one or more feature maps from the one or more feature maps 118 and the convolution kernels 114 of any of the convolution layers 112 that are not required for processing the current input. Therefore, the convolutional neural network 110 may use fewer computations, require less memory, and/or consume less power than the conventional neural networks.

Further, since the one or more weights 134 for the corresponding convolution layer may be dynamically defined by the weight generation network 130 of the CNN system 100, a size of the convolutional neural network 110 may be reduced without negatively affecting the accuracy of the CNN system 100. Specifically, a number of the convolution kernels 114 may be reduced, which in turn may reduce a number of feature maps 118. Therefore, the weight generation network 130 of the CNN system 100 may provide a compression that may reduce the number of active feature maps 118 at any instance in the convolutional neural network 110. This may reduce computational, memory, and power resources requirement of the convolutional neural network 110. Thus, the CNN system 100 may have improved computational efficiency may result in reduced run-time of the convolutional neural network 110. This may further enable the implementation of the convolutional neural network 110 in the computing device A having strict power, storage, and computational resources constraints, for example, in the mobile devices (such as smartphones, tablets, laptops, personal digital assistant (PDA), wearable devices, personal computers, vehicles, drones, and so forth).

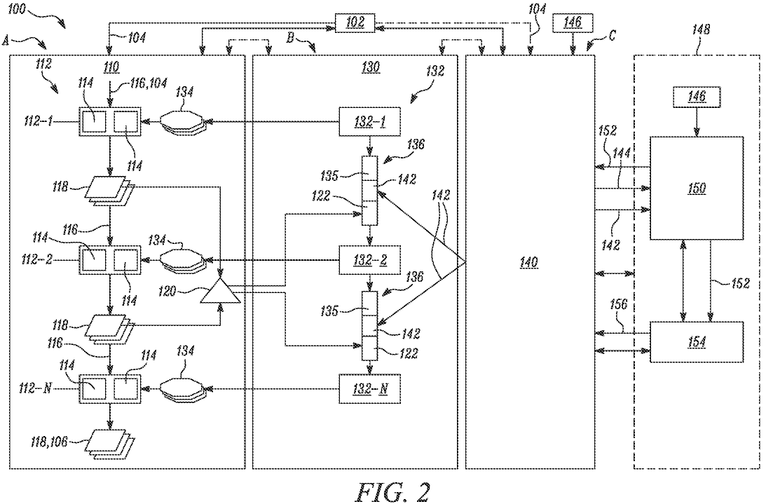

FIG. 2 illustrates a schematic block diagram of the CNN system 100, according to another embodiment of the present disclosure. In the illustrated embodiment of FIG. 2, the CNN system 100 further includes an additional neural network 140. In some embodiments, the additional neural network 140 may be implemented in a computing device C. The additional neural network 140 is selectively coupled to the weight generation network 130. Specifically, the computing device C may be selectively coupled to the computing device B. In some embodiments, the computing device C may have higher power, storage, and/or computational resources than of the computing devices A, B. In some other embodiments, the additional neural network 140 may be implemented in the computing device A.

The additional neural network 140 is configured to generate one or more long-term adaptation features 142. The additional neural network 140 may further provide the one or more long-term adaptation features 142 to the weight generation network 130. Specifically, the additional neural network 140 may further provide the one or more long-term adaptation features 142 to one or more weight generators 132 of the weight generation network 130. In some embodiments, the additional neural network 140 may be selectively coupled to multiple devices similar to the computing device B to provide the one or more long-term adaptation features 142 to the multiple devices.

Further, the vector 136 may be further based on the one or more long-term adaptation features 142. In other words, the vector 136 used to generate the one or more weights 134 for the corresponding weight generator 132 may be based on the one or more long-term adaptation features 142 in addition to the one or more weight indicators 135 generated by the previous weight generator 132 and/or the statistical parameters 122 of the preceding convolution layers 112. The one or more long-term adaptation features 142 may be re-used to update the vector 136 when the additional neural network 140 is not coupled to the computing device B.

In some embodiments, the CNN system 100 further includes a training module 148. The training module 148 is used to train the additional neural network 140. In some embodiments, the additional neural network 140 includes the training module 148. In some embodiments, the training module 148 may be communicably coupled to the additional neural network 140. In some embodiments, the training module 148 may be selectively coupled to the additional neural network 140.

In some embodiments, the training module 148 includes a reference network 150. In some embodiments, the reference network 150 is a subset of the convolutional neural network 110. In some embodiments, the reference network 150 is a copy or replica of the convolutional neural network 110. In some embodiments, the reference network 150 may further include a subset or a copy of the weight generation network 130. Therefore, in some embodiments, the reference network 150 may be a subset or a copy of both the convolutional neural network 110 and the weight generation network 130.

Reference data 146 is provided to the reference network 150. The reference data 146 is indicative of variations in the one or more weights 134 generated by the weight generators 132 over a predetermined period of time. In some embodiments, the reference data 146 is further indicative of variations in the sensor data 104 over a predetermined period of time. Therefore, the reference data 146 may be indicative of long-term variations in the one or more weights 134 and/or long-term variations in the sensor data 104.

In some embodiments, the additional neural network 140 provides the one or more long-term adaptation features 142 to the reference network 150. In some embodiments, the reference network 150 is configured to generate reference output data 152 based on the one or more long-term adaptation features 142. In some embodiments, the reference network 150 is configured to transmit the reference output data 152 to the additional neural network 140. The reference output data 152 may be indicative of a quality of the one or more long-term adaptation features 142.

In some embodiments, the training module 148 further includes a feedback unit 154 communicably connected to the reference network 150 and the additional neural network 140. In some embodiments, the reference network 150 is configured to transmit the reference output data 152 to the feedback unit 154. The feedback unit 154 is configured to receive the reference output data 152 and generate feedback data 156 based on the reference output data 152. The feedback data 156 may train the additional neural network 140. In other words, the additional neural network 140 is configured to receive the feedback data 156 to adjust one or more weights of the additional neural network 140 to obtain optimized data 144. In some embodiments, the optimized data 144 may further be transmitted to the reference network 150. Therefore, the feedback unit 154 may validate the quality of the additional neural network 140 or ensure that the quality of the additional neural network 140 is acceptable based on the reference output data 152. The quality may be an indicator of an operation of additional neural network 140, such as accuracy, run-time, computational efficiency, and/or power consumption for a target application on a target hardware.

Further, the training module 148 may train the additional neural network 140 by a self-supervised or unsupervised optimization process. Due to the inclusion of the reference network 150, the additional neural network 140 may train itself while being decoupled from the convolutional neural network 110 and/or the weight generation network 130. In some cases, the self-supervised or unsupervised optimization process can use object tracking information to compute consistency of predictions. In some cases, the self-supervised or unsupervised optimization process may further use denoising or reconstruction losses (e.g., using the feedback unit 154). In some cases, the self-supervised or unsupervised optimization process may use contrastive, predictive, or generative learning targets. In some embodiments, the additional neural network 140 may further be provided reference data 146.

In some embodiments, the additional neural network 140 may be communicably coupled to the at least one sensor 102. Specifically, the computing device C may be communicably coupled to the at least one sensor 102. The additional neural network 140 may further be provided the sensor data 104. In some embodiments, the additional neural network 140 may be selectively coupled to the at least one sensor 102.

In some embodiments, the one or more long-term adaptation features 142 are generated based on at least one of the optimized data 144, the sensor data 104, and the reference data 146.

Generally, the conventional convolutional neural networks are trained on a specific set of data that may represent typical input data provided to the conventional convolutional neural networks to solve intended task(s), such as image recognition. However, such set of data may not possibly cover all the possible variations of the input data. This may also be due to the fact that the set of data used to train the conventional convolutional neural networks may not be collected at the same location and/or using a same sensor. Further, there may be a domain shift in data over time. For example, the sensor (e.g., the at least one sensor 102) may change over time due to aging and/or environmental factors. In a further example, object appearances may change over time, such as shapes and/or types of vehicles, clothing of peoples, weather conditions, and so forth.

In such cases, the conventional convolutional neural networks may not be adequately trained and therefore may not provide an accurate output data. One solution to reduce such cases is to provide ample redundancy to cover such variations by using a very diverse set of data to train the conventional convolutional neural networks. However, this may lead to an increase in requirement of the computational, memory, and power resources. Further, there may still be a need to fine-tune and update the conventional convolutional neural network after a period of time to compensate for the domain shift in data over time.

Since the vector 136 which is used to generate the one or more weights 134 for the corresponding weight generator 132 is based on the one or more long-term adaptation features 142, the weight generator 132 may be highly adaptive to the domain shift in data over time. Therefore, there may not be a need to fine-tune and update the convolutional neural network 110 or the learned weights 134 of the CNN system 100 of the present disclosure to compensate for the domain shift in data over time.

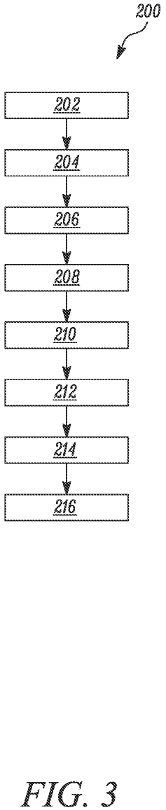

FIG. 3 illustrates a flowchart depicting a computer-implemented method 200 for dynamically generating weights for the CNN system 100 (shown in FIGS. 1A and 2), according to an embodiment of the present disclosure. In some embodiments, a computer program product including a computer readable medium having computer readable code embodied therein may be configured such that, on execution by a suitable computer unit, causes the computer unit to perform the computer-implemented method 200. In some embodiments, the computer program product may be downloaded and installed in the computer unit.

The computer-implemented method 200 will be further described with reference to FIGS. 1A-1D and 2. The computer-implemented method 200 may be interchangeably referred to as “the method 200”.

At step 202, the method 200 includes generating the sensor data 104.

At step 204, the method 200 includes providing the convolutional neural network 110 including the plurality of sequentially arranged convolution layers 112.

At step 206, the method 200 includes initializing the convolution neural network 110. The convolution neural network 110 may be required to be initialized for dynamically generating weights for the CNN system 100 at a first instance. However, the convolution neural network 110 may not be required to be initialized for dynamically generating weights for the CNN system 100 at subsequent instances.

At step 208, the method 200 includes defining the corresponding one or more convolution kernels 114 in each of the plurality of sequentially arranged convolution layers 112. In some embodiments, the corresponding one or more convolution kernels 114 in each of the plurality of sequentially arranged convolution layers 112 are defined upon initialization of the convolution neural network 110.

At step 210, the method 200 includes receiving the corresponding previous data 116 by each of the plurality of sequentially arranged convolution layers 112.

At step 212, the method 200 includes convoluting the corresponding previous data 116 with the corresponding one or more convolution kernels 114 to generate the one or more feature maps 118.

At step 214, the method 200 includes providing the weight generation network 130 communicably coupled to the convolutional neural network 110 and including the plurality of sequentially arranged weight generators 132 coupled to the plurality of sequentially arranged convolution layers 112.

At step 216, the method 200 includes dynamically generating the one or more weights 134 for the one or more convolution kernels 114 of one or more of the plurality of sequentially arranged convolution layers 112 at the run-time based on the vector 136. In some embodiments, the method 200 includes providing the vector to the subsequent weight generator 132 as the input for dynamically generating the one or more weights 134 for the one or more convolution kernels 114 of the corresponding sequentially arranged convolution layer 112 at the run-time.

In some embodiments, the method 200 includes transmitting the one or more feature maps 118 to the features statistic module 120.

In some embodiments, the method 200 includes computing, via the features statistic module 120, the statistical parameters 122 for one or more of the plurality of sequentially arranged convolution layers 112 based on the corresponding one or more feature maps 118.

In some embodiments, the method 200 further includes selectively coupling the additional neural network 140 to the weight generation network 130 and generating the one or more long-term adaptation features 142 via the additional neural network 140.

In some embodiments, the method 200 includes training the additional neural network 140 via the training module 148.

In some embodiments, training the additional neural network 140 includes providing the reference network 150, providing the one or more long-term adaptation features 142 to the reference network 150 via the additional neural network 140, and generating the reference output data 152 via the reference network 150 based on the one or more long-term adaptation features 142. In some embodiments, the method 200 includes transmitting the reference output data 152, via the reference network 150, to the additional neural network 140.

In some embodiments, training the additional neural network 140 includes providing the feedback unit 154 communicably connected to the reference network 150 and the additional neural network 140, transmitting the reference output data 152, via the reference network 150, to the feedback unit 154, and generating the feedback data 156 via the feedback unit 154 based on the reference output data 152 upon receiving the reference output data 152. In such embodiments, training the additional neural network 140 further includes transmitting the feedback data 156 to the additional neural network 140 and adjusting the one or more long-term adaptation features 142 to obtain the optimized data 144.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multithreaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

### List of Elements

CONVOLUTIONAL NEURAL NETWORK SYSTEM, METHOD FOR DYNAMICALLY DEFINING WEIGHTS, AND COMPUTER-IMPLEMENTED METHOD THEREOF

| | |
|---|---|
| 100 | Convolutional Neural Network (CNN) System |
| 102 | Sensor |
| 104 | Sensor Data |
| 106 | Output Data |
| A | Computing Device |
| 110 | Convolutional Neural Network |
| 112 | Convolution Layers |
| 112-1 | First Convolution Layer |
| 112-2 | Convolution Layer |
| 112-N | Final Convolution Layer |
| 114 | Convolution Kernels |
| 116 | Previous Data |
| 118 | Feature Maps |
| 120 | Features Statistic Module |
| 122 | Statistical Parameter |
| B | Computing Device |
| 130 | Weight Generation Network |
| 132 | Weight Generators |
| 132-1 | First Weight Generator |
| 132-2 | Weight Generator |
| 132-N | Final Weight Generator |
| 133 | List |
| 133A | First Group |
| 133B | Second Group |
| 134 | Weights |
| 135 | Weight Indicator |
| 136 | Vector |
| 140 | Additional Neural Network |
| 142 | Long-Term Adaptation Features |
| 144 | Optimized Data |
| 146 | Reference Data |
| 148 | Training Module |
| 150 | Reference Network |
| 152 | Reference Output Data |
| 154 | Feedback Unit |
| 156 | Feedback Data |
| 200 | Computer-Implemented Method |
| 202 | Step |
| 204 | Step |
| 204 | Step |
| 206 | Step |
| 208 | Step |
| 210 | Step |
| 212 | Step |
| 214 | Step |
| 216 | Step |

1. A convolutional neural network system comprising:
at least one sensor configured to generate sensor data;
a convolutional neural network, the convolutional neural network comprising:
a plurality of sequentially arranged convolution layers comprising corresponding one or more convolution kernels, wherein each of the plurality of sequentially arranged convolution layers is configured to receive corresponding previous data, wherein the corresponding previous data is convolved with the corresponding one or more convolution kernels to generate one or more feature maps, wherein the sensor data is the corresponding previous data for a first convolution layer from the plurality of sequentially arranged convolution layers, wherein the one or more feature maps are the corresponding previous data for a subsequent convolution layer from the plurality of sequentially arranged convolution layers, and wherein the one or more feature maps of a final convolution layer from the plurality of sequentially arranged convolution layers comprise output data;
a weight generation network communicably coupled to the convolutional neural network, the weight generation network comprising:
a plurality of sequentially arranged weight generators coupled to the plurality of sequentially arranged convolution layers, wherein one or more of the plurality of sequentially arranged weight generators are configured to dynamically generate one or more weights for the one or more convolution kernels of one or more of the plurality of sequentially arranged convolution layers at a run-time based on a vector, wherein the vector is based on one or more weight indicators indicative of the one or more weights generated by a previous weight generator.

2. The convolutional neural network system of claim 1, wherein the one or more of the plurality of sequentially arranged weight generators are configured to dynamically generate the one or more weights for the one or more convolution kernels of the plurality of sequentially arranged convolution layers at the run-time based on the one or more feature maps generated by one or more preceding convolution layers.

3. The convolutional neural network system of claim 1 further comprising a features statistic module configured to receive the one or more feature maps and compute statistical parameters for one or more of the plurality of sequentially arranged convolution layers based on the corresponding one or more feature maps, wherein the vector is further based on the statistical parameters of the preceding convolution layers.

4. The convolutional neural network system of claim 3, wherein the statistical parameters comprise at least one of an average value, a variance value, a maximum value, and a minimum value.

5. The convolutional neural network system of claim 1, wherein the plurality of sequentially arranged weight generators correspond to the plurality of sequentially arranged convolution layers.

6. The convolutional neural network system of claim 5, wherein a subsequent weight generator from the plurality of sequentially arranged weight generators receives the vector as an input to dynamically generate the one or more weights for the one or more convolution kernels of the corresponding sequentially arranged convolution layer at the run-time.

7. The convolutional neural network system of claim 1 further comprising an additional neural network selectively coupled to the weight generation network, wherein the additional neural network is configured to generate one or more long-term adaptation features, and wherein the vector is further based on the one or more long-term adaptation features.

8. The convolutional neural network system of claim 7, wherein the one or more long-term adaptation features are generated based on at least one of optimized data, the sensor data, and reference data, and wherein the reference data is indicative of variations in the one or more weights generated by the plurality of sequentially arranged weight generators over a predetermined period of time and variations in the sensor data over a predetermined period of time.

9. The convolutional neural network system of claim 7 further comprising a training module, wherein the training module is used to train the additional neural network.

10. The convolutional neural network system of claim 9, wherein the training module comprises a reference network, wherein the reference network is a subset of the convolutional neural network, wherein the additional neural network provides the one or more long-term adaptation features to the reference network, and wherein the reference network is configured to generate reference output data based on the one or more long-term adaptation features.

11. The convolutional neural network system of claim 10, wherein the reference network is configured to transmit the reference output data to the additional neural network.

12. The convolutional neural network system of claim 11, wherein the training module further comprises a feedback unit communicably connected to the reference network and the additional neural network, wherein the reference network is configured to transmit the reference output data to the feedback unit, wherein the feedback unit is configured to receive the reference output data and generate feedback data based on the reference output data, and wherein the additional neural network is configured to receive the feedback data to adjust one or more weights of the additional neural network to obtain the optimized data.

13. The convolutional neural network system of claim 1, wherein the at least one sensor comprises a lidar sensor, and wherein the sensor data comprises point cloud data.

14. The convolutional neural network system of claim 1, wherein the weight generation network comprises a multi-layer perceptron structure.

15. A computer-implemented method for dynamically generating weights for a convolutional neural network system comprising:
generating sensor data;
providing a convolutional neural network comprising a plurality of sequentially arranged convolution layers;
initializing the convolution neural network;
defining corresponding one or more convolution kernels in each of the plurality of sequentially arranged convolution layers;
receiving corresponding previous data by each of the plurality of sequentially arranged convolution layers;
convoluting the corresponding previous data with the corresponding one or more convolution kernels to generate one or more feature maps, wherein the sensor data is the corresponding previous data for a first convolution layer from the plurality of sequentially arranged convolution layers, wherein the one or more feature maps are the corresponding previous data for a subsequent convolution layer from the plurality of sequentially arranged convolution layers, and wherein the one or more feature maps of a final convolution layer from the plurality of sequentially arranged convolution layers comprise output data;
providing a weight generation network communicably coupled to the convolutional neural network and comprising a plurality of sequentially arranged weight generators coupled to the plurality of sequentially arranged convolution layers; and
dynamically generating one or more weights for the one or more convolution kernels of one or more of the plurality of sequentially arranged convolution layers at a run-time based on a vector, wherein the vector is based on one or more weight indicators indicative of the one or more weights generated by a previous weight generator.

16. The computer-implemented method of claim 15 further comprising:
transmitting the one or more feature maps to a features statistic module; and
computing, via the features statistic module, statistical parameters for one or more of the plurality of sequentially arranged convolution layers based on the corresponding one or more feature maps, wherein the vector is further based on the statistical parameters of each of the preceding convolution layers.

17. The computer-implemented method of claim 15, wherein the plurality of sequentially arranged weight generators correspond to the plurality of sequentially arranged convolution layers.

18. The computer-implemented method of claim 17 further comprising providing the vector to a subsequent weight generator as an input for dynamically generating the one or more weights for the one or more convolution kernels of the corresponding sequentially arranged convolution layer at the run-time.

19. The computer-implemented method of claim 15, wherein the corresponding one or more convolution kernels in each of the plurality of sequentially arranged convolution layers are defined upon initialization of the convolution neural network.

20. The computer-implemented method of claim 15 further comprising selectively coupling an additional neural network to the weight generation network and generating one or more long-term adaptation features via the additional neural network, wherein the vector is further based on the one or more long-term adaptation features.

21. The computer-implemented method of claim 20, wherein the one or more long-term adaptation features are generated based on at least one of optimized data, the sensor data, and reference data, and wherein the reference data is indicative of variations in the one or more weights generated by the plurality of sequentially arranged weight generators over a predetermined period of time and variations in the sensor data over a predetermined period of time.

22. The computer-implemented method of claim 21 further comprising training the additional neural network via a training module, wherein training the additional neural network comprises:
providing a reference network, wherein the reference network is a subset of the convolutional neural network; and
providing the one or more long-term adaptation features to the reference network via the additional neural network; and
generating reference output data via the reference network based on the one or more long-term adaptation features.

23. The computer-implemented method of claim 22 further comprising transmitting the reference output data, via the reference network, to the additional neural network.

24. The computer-implemented method of claim 22, wherein training the additional neural network further comprises:
providing a feedback unit communicably connected to the reference network and the additional neural network;
transmitting the reference output data, via the reference network, to the feedback unit;
generating feedback data, via the feedback unit, based on the reference output data upon receiving the reference output data;
transmitting the feedback data to the additional neural network; and
adjusting one or more weights of the additional neural network to obtain the optimized data.

25. A computer program product comprising a computer readable medium having computer readable code embodied therein, the computer readable code being configured such that, on execution by a suitable computer unit, causes the computer unit to:
generate sensor data;
provide a convolutional neural network comprising a plurality of sequentially arranged convolution layers;
initialize the convolution neural network;
define corresponding one or more convolution kernels in each of the plurality of sequentially arranged convolution layers;
receive corresponding previous data by each of the plurality of sequentially arranged convolution layers;
convolve the corresponding previous data with the corresponding one or more convolution kernels to generate one or more feature maps, wherein the sensor data is the corresponding previous data for a first convolution layer from the plurality of sequentially arranged convolution layers, wherein the one or more feature maps are the corresponding previous data for a subsequent convolution layer from the plurality of sequentially arranged convolution layers, and wherein the one or more feature maps of a final convolution layer from the plurality of sequentially arranged convolution layers comprise output data;
provide a weight generation network communicably coupled to the convolutional neural network and comprising a plurality of sequentially arranged weight generators coupled to the plurality of sequentially arranged convolution layers; and
dynamically generate one or more weights for the one or more convolution kernels of one or more of the plurality of sequentially arranged convolution layers at a run-time based on a vector, wherein the vector is based on one or more weight indicators indicative of the one or more weights generated by a previous weight generator.
